(19) United States
(12) Patent Application Publication
(10) Pub. No.: US 2003/0210364 A1
(43) Pub. Date: Nov. 13, 2003

(54) Reflective liquid crystal display substrate with integrated reflection enhancing and alignment layers

(75) Inventor: Hui-Lun Chen, Hsinchu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/144,016

(22) Filed: May 13, 2002

(51) Int. Cl. G02F 1/1337

(52) U.S. Cl. 349/113

(57) ABSTRACT

Within a reflective liquid crystal on silicon display image array optoelectronic microelectronic fabrication there is employed a polyimide alignment layer formed upon a reflection enhancing layer. The reflective liquid crystal on silicon display image array optoelectronic microelectronic fabrication is fabricated with enhanced liquid crystal material alignment and enhanced contrast.

### BACKGROUND OF THE INVENTION

1. Field of the Invention

The present invention relates generally to methods for fabricating reflective liquid crystal display substrates. More particularly, the present invention relates to methods for efficiently fabricating reflective liquid crystal display substrates.

2. Description of the Related Art

Microelectronic fabrications may be generally categorized as either purely electronic microelectronic fabrications or optoelectronic microelectronic fabrications. Purely electronic microelectronic fabrications employ electrical circuits for purposes of data storage and processing, while in comparison optoelectronic microelectronic fabrications employ electrical circuits in conjunction with optical components for purposes of data storage, transduction and processing. Common examples of optoelectronic microelectronic fabrications include sensor image array optoelectronic microelectronic fabrications (such as are employed within digital cameras), as well as display image array optoelectronic microelectronic fabrications (such as are employed within computer graphical user interfaces (GUI's)).

With respect in particular to display image array optoelectronic microelectronic fabrications, it has become increasingly common in the art of microelectronic fabrication to fabricate display image array optoelectronic microelectronic fabrications as reflective liquid crystal display image array optoelectronic microelectronic fabrications. Such reflective liquid crystal display image array optoelectronic microelectronic fabrications typically employ a liquid crystal material interposed between a transparent electrode and a reflective electrode, such that modulation of a charge of the transparent electrode with respect to the reflective electrode provides for spatial modulation of light incident upon and reflected from the reflective electrode.

While reflective liquid crystal display image array optoelectronic microelectronic fabrications are thus clearly desirable in the art of microelectronic fabrication and often essential in the art of microelectronic fabrication, reflective liquid crystal display image array optoelectronic microelectronic fabrications are nonetheless not entirely without problems in the art of optoelectronic microelectronic fabrication.

In that regard, reflective liquid crystal display image array optoelectronic microelectronic fabrications are not always efficiently fabricated with optimal liquid crystal material alignment and with optimal contrast in the art of optoelectronic microelectronic fabrication.

It is thus desirable in the art of optoelectronic microelectronic fabrication to provide methods and materials for fabricating within the art of optoelectronic microelectronic fabrication reflective liquid crystal display image array optoelectronic microelectronic fabrications with enhanced liquid crystal material alignment and contrast.

It is towards the foregoing object that the present invention is directed.

Various optoelectronic microelectronic fabrications having desirable properties, and methods for fabrication thereof, have been disclosed in the art of optoelectronic microelectronic fabrication. Included among the optoelectronic microelectronic fabrications and methods for fabrication thereof, but not limiting among the optoelectronic microelectronic fabrications and methods for fabrication thereof, are optoelectronic microelectronic fabrications and methods for fabrication thereof disclosed within:

(1) Moore, in U.S. Pat. No. 6,124,912 (an optoelectronic microelectronic fabrication employing laminated pairs of dielectric layers, of differing dielectric constants, as reflection enhancing layers within the optoelectronic microelectronic fabrication); and

(2) Scherer et al., in U.S. Pat. No. 6,208,398 (a liquid crystal display image array optoelectronic microelectronic fabrication with enhanced liquid crystal material alignment by forming a bottom plate within the liquid crystal display image array optoelectronic microelectronic fabrication with a porous structure).

Desirable in the art of optoelectronic microelectronic fabrication are additional methods and materials which may be employed for fabricating reflective liquid crystal display image array optoelectronic microelectronic fabrications with enhanced liquid crystal material alignment and enhanced contrast.

It is towards the foregoing objects that the present invention is directed.

### SUMMARY OF THE INVENTION

A first object of the present invention is to provide a reflective liquid crystal display image array optoelectronic microelectronic fabrication and a method for fabricating the reflective liquid crystal display image array optoelectronic microelectronic fabrication.

A second object of the present invention is to provide the reflective liquid crystal display image array optoelectronic microelectronic fabrication and the method for fabricating the reflective liquid crystal display image array optoelectronic microelectronic fabrication in accord with the first object of the present invention, wherein the reflective liquid crystal display image array optoelectronic microelectronic fabrication is fabricated with enhanced liquid crystal material alignment and enhanced contrast.

A third object of the present invention is to provide the reflective liquid crystal display image array optoelectronic microelectronic fabrication and the method for fabricating the reflective liquid crystal display image array optoelectronic microelectronic fabrication in accord with the first object of the present invention and the second object of the present invention, wherein the method is readily commercially implemented.

In accord with the objects of the present invention, there is provided by the present invention a series of reflective liquid crystal display image array optoelectronic microelectronic fabrications and a series of methods for fabricating the series of reflective liquid crystal display image array optoelectronic microelectronic fabrications.

In general, the present invention provides a series of reflective liquid crystal display image array optoelectronic microelectronic fabrications which employ a series of silicon oxide layers or silicon oxide/silicon nitride stack layers as reflection enhancing layers, in conjunction with a series of polyimide alignment layers formed upon the silicon oxide or silicon oxide/silicon nitride stack layers as reflection enhancing layers.

The methods of the present invention are readily commercially implemented.

The present invention employs methods and materials as are generally known in the art of optoelectronic microelectronic fabrication, but employed within the context of a specific structural composition to provide the present invention.

Since it is thus at least in part a structural composition which provides at least in part the present invention, rather than the existence of methods and materials which provides the present invention, the method of the present invention is readily commercially implemented.

### BRIEF DESCRIPTION OF THE DRAWINGS

The objects, features and advantages of the present invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic cross-sectional diagram of a reflective liquid display image array optoelectronic microelectronic fabrication which may be fabricated in accord with the present invention.

FIG. 2 shows a graph of Reflectivity Percent versus Wavelength for various passivation stack compositions which may be employed within the context of the preferred embodiment of the present invention.

### DESCRIPTION OF THE PREFERRED EMBODIMENT

The present invention provides a series of reflective liquid crystal display image array optoelectronic microelectronic fabrications and a series of methods for fabricating the series of reflective liquid crystal display image array optoelectronic microelectronic fabrications, wherein the series of reflective liquid crystal display image array optoelectronic microelectronic fabrications is fabricated with enhanced liquid crystal material alignment and enhanced contrast.

To realize the foregoing object, in general, the present invention provides a series of reflective liquid crystal display image array optoelectronic microelectronic fabrications which employs a series of silicon oxide layers or silicon oxide/silicon nitride stack layers as reflection enhancing layers, in conjunction with a series of polyimide alignment layers formed upon the silicon oxide or silicon oxide/silicon nitride stack reflection enhancing layers.

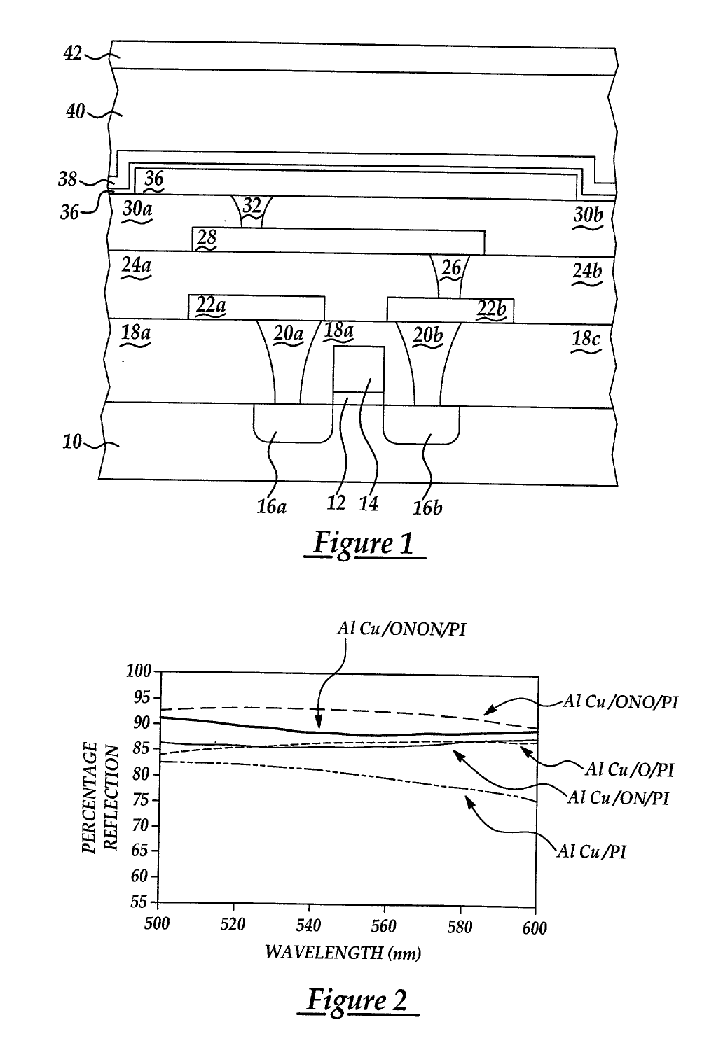

Referring now to FIG. 1, there is shown a schematic cross-sectional diagram of a reflective liquid crystal display image array optoelectronic microelectronic fabrication within which may be practiced the present invention.

Shown in FIG. 1, in a first instance, is a semiconductor substrate 10 having formed therein a field effect transistor (FET) device comprising a gate electrode 14 formed aligned upon a gate dielectric layer 12, and a pair of source/drain regions 16a and 16b formed into the semiconductor substrate 10 adjacent the gate dielectric layer 12 having formed aligned thereupon the gate electrode 14.

Shown also within the schematic cross-sectional diagram of FIG. 1, and formed contacting each of the pair of source/drain regions 16a and 16b is a pair of conductor stud layers 20a and 20b, which in turn is electrically connected to a pair of patterned first conductor layers 22a and 22b. Similarly, one of the patterned first conductor layers 22b is connected through a first interconnection stud 26 to a patterned second conductor layer 28 which is in turn electrically connected to a reflective electrode mirror 34 through a second interconnection stud 32.

As is also illustrated within the schematic cross-sectional diagram of FIG. 1: (1) there is shown a series of patterned pre-metal dielectric layers 18a, 18b and 18c separating the pair of patterned first conductor layers 22a and 22b from the field effect transistor (FET) device; (2) there is shown a pair of patterned inter-metal dielectric layers 24a and 24b separating the pair of patterned first conductor layers 22a and 22b from the patterned second conductor layer 28; and (3) there is shown a pair of patterned second inter-metal dielectric layers 30a and 30b separating the patterned second conductor layer 28 from the reflective electrode mirror 34.

Similarly, there is shown within the schematic cross-sectional diagram of FIG. 1 the reflective electrode mirror 34 having formed thereupon a reflection enhancing layer 36 in turn having formed thereupon an alignment layer 38. Finally, there is also shown within the schematic cross-sectional diagram of FIG. 1 formed upon the alignment layer 38 a liquid crystal material layer 40 and formed upon the liquid crystal material layer 40 a transparent electrode 42 which is often formed upon an interior surface of a glass plate.

Within the preferred embodiment of the present invention with respect to the reflectivity enhancing layer 36, the reflectivity enhancing layer 36 is provided as one of several options within the context of the present invention.

Included first among the options is a single reflection enhancing layer 36 formed of a silicon oxide material. Included next among the options for the reflection enhancing layer 36 is s silicon oxide/silicon nitride/silicon oxide stack layer. Included yet next among the options for the reflection enhancing layer 36 is a silicon oxide/silicon nitride/silicon oxide/silicon nitride/silicon oxide stack layer.

Included also among the options for the reflection enhancing layer 36 is a silicon oxide/silicon nitride stack layer.

Within the context of the present invention and the preferred embodiment of the present invention, the series of reflection enhancing stack layers is provided with silicon oxide layer thicknesses and a silicon nitride layer thicknesses, either of which is intended as representative of a thickness approximately equal to one-quarter of a central wavelength of a visible spectrum whose reflection is enhanced while employing the reflection enhancing layer 36.

Within the preferred embodiment of the present invention with respect to the alignment layer 38, the alignment layer 38 is typically and preferably formed of a polyimide material layer formed to a thickness of from about 600 to about 800 angstroms. The alignment layer serves to assist in aligning liquid crystal material layer 40 deposited upon the alignment layer 38.

Finally, with respect to the transparent electrode 42 which is typically formed laminated as a bottom layer of a transparent glass plate, the transparent electrode 42 is typically and preferably formed of an indium-tin oxide material.

Referring now to FIG. 2, there is shown a graph of Percentage Reflectance versus Wavelength for a series of alignment layer 38 and reflection enhancing layer 36 combinations in accord with the present invention. As is illustrated within the graph of FIG. 2, absent a reflection enhancing layer 36, there is a generalized decrease of reflectance from an aluminum-copper reflective electrode in the 500 to 600 nanometer wavelength region. Similarly, with the presence of any of the reflection enhancing layer combinations in accord with the present invention, reflectivity, particularly in the 550 to 600 nanometer wavelength region, is enhanced.

As is understood by a person skilled in the art, the preferred embodiments of the present invention are illustrative of the present invention rather than limiting of the present invention. Revisions and modifications may be made to methods, materials, structures and dimensions employed for fabricating a reflective liquid crystal on silicon display image array optoelectronic microelectronic fabrication in accord with the preferred embodiments of the present invention, while still providing a reflective liquid crystal optoelectronic microelectronic fabrication in accord with the present invention, further in accord with the accompanying claims.

What is claimed is:

1. A liquid crystal optoelectronic microelectronic fabrication comprising:
a substrate;
a reflective electrode formed over the substrate;
a silicon oxide layer formed upon the reflective electrode; and
a polyimide alignment layer formed upon the silicon oxide layer.

2. The liquid crystal optoelectronic microelectronic fabrication of claim 1 wherein the silicon oxide layer is formed to a thickness of from about 300 to about 1500 angstroms.

3. The liquid crystal optoelectronic microelectronic fabrication of claim 1 wherein the polyimide alignment layer is formed to a thickness of from about 200 to about 1500 angstroms.

4. A liquid crystal optoelectronic microelectronic fabrication comprising:
a substrate;
a reflective electrode formed over the substrate;
at least one pair of a silicon nitride layer formed upon a silicon oxide layer formed upon the reflective electrode; and
a polyimide alignment layer formed upon the silicon nitride layer.

5. The liquid crystal optoelectronic microelectronic fabrication of claim 4 wherein the silicon nitride layer is formed to a thickness of from about 300 to about 1500 angstroms.

6. The liquid crystal optoelectronic microelectronic fabrication of claim 4 wherein the silicon oxide layer is formed to a thickness of from about 300 to about 1500 angstroms.

7. The liquid crystal optoelectronic microelectronic fabrication of claim 4 wherein the polyimide alignment layer is formed to a thickness of from about 200 to about 1500 angstroms.

8. A liquid crystal optoelectronic microelectronic fabrication comprising:
a substrate;
a reflective electrode formed over the substrate;
at least one pair of a silicon nitride layer formed upon a silicon oxide layer formed upon the reflective electrode;
an additional silicon oxide layer formed upon the silicon nitride layer; and
a polyimide alignment layer formed upon the silicon nitride layer.

9. The liquid crystal optoelectronic microelectronic fabrication of claim 8 wherein the silicon nitride layer is formed to a thickness of from about 300 to about 1500 angstroms.

10. The liquid crystal optoelectronic microelectronic fabrication of claim 8 wherein the silicon oxide layer is formed to a thickness of from about 300 to about 1500 angstroms.

11. The liquid crystal optoelectronic microelectronic fabrication of claim 8 wherein the polyimide alignment layer is formed to a thickness of from about 200 to about 1500 angstroms.

12. A method for fabricating a liquid crystal optoelectronic microelectronic fabrication comprising:
providing a substrate;
forming over the substrate a reflective electrode;
forming upon the reflective electrode a silicon oxide layer; and
forming upon the silicon oxide layer a polyimide alignment layer.

13. The method of claim 12 wherein the silicon oxide layer is formed to a thickness of from about 300 to about 1500 angstroms.

14. The method of claim 12 wherein the polyimide alignment layer is formed to a thickness of from about 200 to about 1500 angstroms.

15. A method for fabricating a liquid crystal optoelectronic microelectronic fabrication comprising:
providing a substrate;
forming over the substrate a reflective electrode;
forming upon the reflective electrode at least one pair of a silicon nitride layer formed upon a silicon oxide layer formed upon the reflective electrode; and
forming upon the silicon nitride layer a polyimide alignment layer.

16. The method of claim 15 wherein the silicon nitride layer is formed to a thickness of from about 300 to about 1500 angstroms.

17. The method of claim 15 wherein the silicon oxide layer is formed to a thickness of from about 300 to about 1500 angstroms.

18. The method of claim 15 wherein the polyimide alignment layer is formed to a thickness of from about 200 to about 1500 angstroms.

19. A method for forming a liquid crystal optoelectronic microelectronic fabrication comprising:
providing a substrate;
forming over the substrate a reflective electrode;
forming upon the reflective electrode at least one pair of a silicon nitride layer formed upon a silicon oxide layer formed upon the reflective electrode;
forming an additional silicon oxide layer upon the silicon nitride layer; and
forming a polyimide alignment layer upon the silicon nitride layer.
